(19) United States
(12) Patent Application Publication
(10) Pub. No.: US 2003/0123098 A1
(43) Pub. Date: Jul. 3, 2003

(54) Method and system receiving e-mail via internet fax with only one point-to-point protocol connection

(75) Inventor: Sung-hoon Bae, Gyeonggi-do (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-City (KR)

(21) Appl. No.: 10/304,057

(22) Filed: Nov. 26, 2002

(30) Foreign Application Priority Data
Dec. 29, 2001 (KR) 2001-88223

(51) Int. Cl. H04N 1/00

(52) U.S. Cl. 358/402

(57) ABSTRACT

An Internet fax receiving e-mails of an Internet fax user with two or more email accounts via an Internet fax by performing a single point-to-point protocol (PPP) connection to the Internet Information on at least two e-mail accounts of a user are set in the Internet fax corresponding to email accounts of the user at email servers. The Internet fax dialing an Internet service provider via a public switched computer network, establishing a PPP connection so that the Internet fax can be connected to the Internet through the Internet service provider in response to a command for receiving the e-mails, sequentially receiving the e-mails stored in the e-mail accounts of the email servers through the Internet service provider, converting data of the received e-mails into print data to be printed by the Internet fax, and printing the print data.

### CROSS-REFERENCE TO RELATED APPLICATIONS

This application claims the benefit of Korean Application No. 2001-88223 filed Dec. 29, 2001, in the Korean Intellectual Property Office, the disclosure of which is incorporated herein by reference.

### BACKGROUND OF THE INVENTION

1. Field of the Invention

The present invention relates to a method of receiving e-mail fax messages via an Internet fax, and more particularly, to a method and system receiving e-mails via an Internet fax by performing a point-to-point protocol (PPP) connection by dialing an Internet service provider via a public switched computer network, and connecting with a plurality of e-mail servers so as to connect to the Internet.

2. Description of the Related Art

Internet fax service is a technique enabling computer users to send a facsimile via the Internet, rather than using the existing public telephone networks. With the spread of facsimile services, routing fax transmissions has been generalized worldwide, but it is disadvantageous in that it costs too much to fax e-mails overseas. However, Internet advances allow one to fax e-mails on the Internet at a low cost. Therefore, a lot of interest has been generated regarding Internet fax services and Internet fax companies are appearing all over the world. Through an Internet fax service, print data can be transmitted via the Internet by adopting one of the recommended ITU-T procedures of T.37 store-and-forward and T.38 real-time. In particular, the T.37 store-and-forward procedure is used to send an e-mail fax by exchanging print data in the form of e-mail. A user who wishes to transmit and/or receive print data through e-mail must first connect to the Internet. At this time, the connection to the Internet may be established through a point-to-point protocol (PPP) connection, using a modem, for example. Conventional Internet faxes receive e-mails by establishing the PPP connection once, and then, connecting to one e-mail server at a time. However, with the existing connection methods, in the event that a user has several e-mail accounts, the PPP connection is required to be repeated as many times as the number of e-mail accounts, thereby requiring a lot of time and increasing costs.

FIG. 1 is a diagram of a conventional system for receiving a plurality of e-mails via an Internet fax 100. This conventional system includes the Internet fax 100 having a facsimile 110 and a converter 120 for converting data of e-mail into print data to be printed by the facsimile 110; Internet service providers (ISP) 140 that are media for connecting the Internet fax 100 and the Internet 150; and first through third mail servers 160, 161, and 162 for storing e-mails 170, 171 and 172 transmitted from first through third e-mail transmitters 180, 181, and 182. The Internet fax 100 is connected to the e-mail servers 160, 161, and 162 via the Internet 150, and also, connected to the ISPs 140 via a public switched computer network 130.

Referring to FIG. 1, a conventional method for receiving a plurality of e-mails of a user via the Internet fax 100 is as follows:

(i) when the first e-mail transmitter 180 sends an e-mail 170 of an Internet fax user to the first mail server 160, the e-mail 170 is stored in the first mail server 160, and then, a command to receive (to retrieve) the e-mail 170 is transmitted to the Internet fax 100 via paths A and B;

(ii) the Internet fax 100 receives the above command, in response to the command, dials the ISP 140 via the public switched computer network 130 to be connected with the Internet 150, and then, establishes the PPP connection;

(iii) once the PPP connection is established, the e-mail 170 is transmitted to the Internet fax 100 via the paths A and B, and the e-mail is converted into print data to be printed by the Internet fax 100;

(iv) when the second e-mail transmitter 181 sends an e-mail 171 of the same Internet fax user, the e-mail 171 is stored in the second mail server 161, a command to receive the e-mail 171 is transmitted to the Internet fax 100 via the paths A and B, the Internet fax 100 terminates the previous PPP connection with the first mail server 160 and connects to the second mail server 161, repeats the above operation (ii) and (iii), and finally, prints the e-mail 171; and

(v) when the third e-mail transmitter 182 sends an e-mail 172 of the same Internet fax user, the Internet fax 100 disconnects from the second mail server 161 and connects to the third mail server 162, repeats the operations (ii) and (iii), and prints the e-mail 172.

However, the above conventional method is disadvantageous because if a user who wishes to use the Internet fax 100 has several e-mail accounts in one e-mail server, or several e-mail accounts in several e-mail servers, the internet fax 100 has to repeat the PPP connection as many times as e-mail accounts of the user to receive all of the e-mails of the user. In other words, as shown in FIG. 1, the internet fax 100 in response to a command (from the user or from the mail server) to retrieve emails of the user, must connect sequentially to the first mail server 180 through the third mail server 182 to receive the e-mails stored therein. Therefore, this conventional method is costly, and time-consuming.

### SUMMARY OF THE INVENTION

To solve at least the above problem, it is an object of the present invention to provide a method and system for receiving a plurality of e-mails of an Internet fax user by performing point-to-point protocol (PPP) connection only once if the Internet fax user has several e-mail accounts in one e-mail server or several e-mail accounts in several e-mail servers.

Additional objects and advantages of the invention will be set forth in part in the description which follows and, in part, will be obvious from the description, or may be learned by practice of the invention.

According to an embodiment of the invention, there is provided a method of receiving a plurality of e-mails via an Internet fax, the method comprising setting at least two e-mail accounts corresponding to e-mail accounts at e-mail servers in the Internet fax; establishing a PPP connection so that the Internet fax is connected to the Internet through an Internet service provider in response to a command for receiving the e-mails of the user; sequentially receiving the e-mails of the user stored in the e-mail accounts of the e-mail servers through the Internet service provider; converting data of the received e-mails into print data to be printed by the Internet fax; and printing the print data.

According to an aspect of the invention, the method further comprises disconnecting the PPP connection from the Internet service provider after the e-mails are completely received.

According to an aspect of the invention, when setting the at least two e-mail accounts, an Internet fax user registers in advance user information regarding the e-mail servers having the at least two e-mail accounts of the Internet fax user in the Internet fax, and the Internet fax stores the user information in a data base.

According to an aspect of the invention, during the PPP connection, the Internet fax dials the Internet service provider through a public switched computer network and establishes the PPP connection such that an Internet connection is achieved.

According to an aspect of the invention, receiving the e-mails comprises connecting the Internet fax to one of the e-mail servers having several e-mail accounts of the Internet fax user registered in the Internet fax, receiving e-mails from the connected e-mail server, disconnecting from the e-mail server when the e-mails are completely received, and repeating these actions sequentially as many times as the number of the e-mail servers.

According to another aspect of the invention, there is provided a system receiving a plurality of e-mails via an Internet fax having a converter that converts data from the received e-mails into print data to be printed by a facsimile, the system comprising setting at least two e-mail accounts corresponding to e-mail accounts at email-servers in the Internet fax; establishing a PPP connection to connect the Internet fax to the Internet through an Internet service provider in response to a command for receiving e-mails from the email-servers; sequentially receiving e-mails stored in the e-mail accounts of the e-mail servers through the Internet service provider; converting data from the received e-mails into print data to be printed by the Internet fax; and printing the print data.

According to an aspect of the invention, the Internet fax further comprises a database storing user information regarding the e-mail servers.

### BRIEF DESCRIPTION OF THE DRAWINGS

The above and other objectives and advantages of the present invention will become more apparent by describing in detail preferred embodiments thereof with reference to the attached drawings in which:

FIG. 1 is a diagram of a conventional system for transmitting and/or receiving a plurality of e-mails via a public switched computer network;

FIG. 2 is a diagram of a system receiving e-mails from a plurality of e-mail accounts of a user having at least two email accounts via Internet fax, according to an embodiment the present invention; and

FIG. 3 is a flowchart of receiving e-mails from a plurality of e-mail accounts of a user having at least two email accounts via Internet fax, using the system of FIG. 2.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures. In particular, a method and system receiving e-mails of an Internet fax user having at least two or more e-mail accounts using a single point-to-point protocol connection via an Internet fax, will be described with reference to the accompanying drawings.

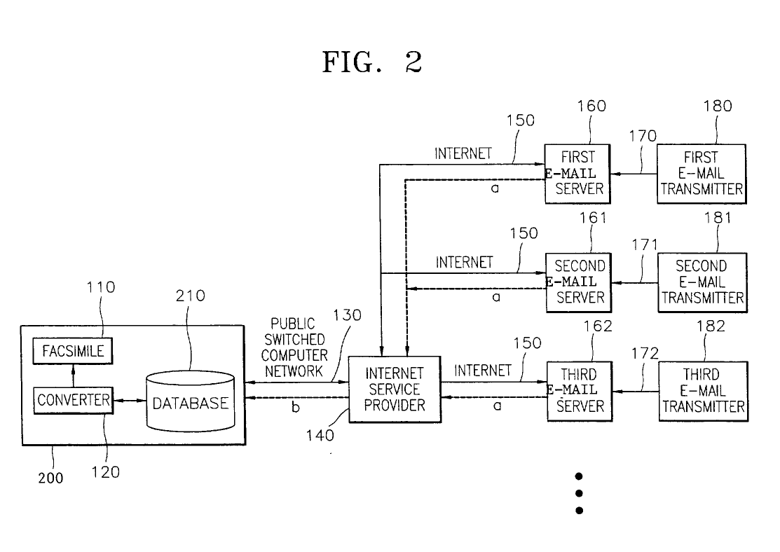

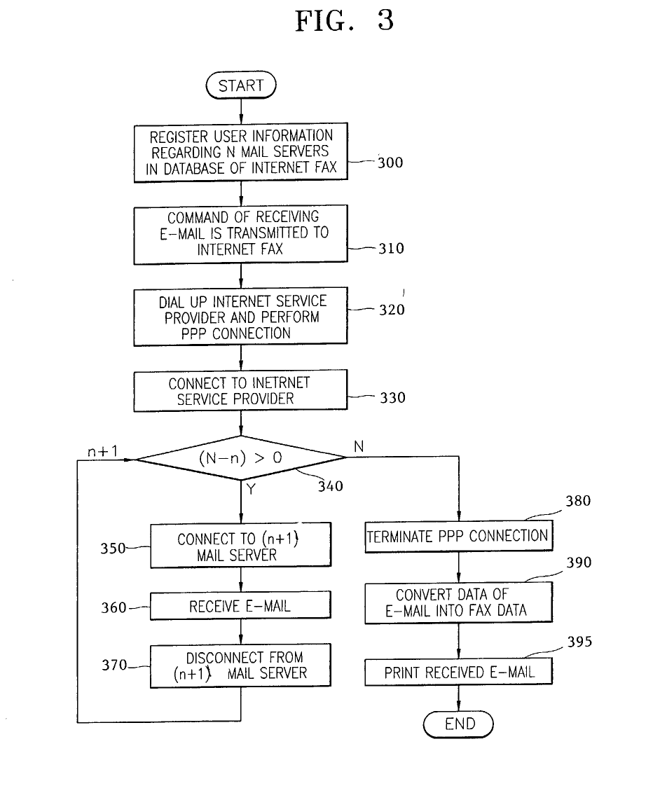

FIG. 2 is a diagram of a system receiving a plurality of e-mails of a user with at least two email accounts via an Internet fax 200, according to an embodiment of the present invention. FIG. 3 is a flowchart of receiving a plurality of e-mails of a user with at least two email accounts via Internet fax using the system of FIG. 2.

The system of FIG. 2 comprises the Internet fax 200 having a converter 120 converting e-mail into print data so as to print an e-mail, and a facsimile 110; an Internet service provider (ISP) 140 that is a medium connecting the Internet fax 200 with the Internet 150; and first through third mail servers 160, 161, and 162 storing e-mails transmitted by e-mail transmitters 180, 181, and 182. The Internet fax 200 is connected to the first through third mail servers 160, 161, and 162, and the Internet 150 through the ISP 140. Also, the Internet fax 200 is connected to the ISP 140 through a public switched computer network 130. According to an aspect of the invention, the Internet fax 200 further comprises a database 210 storing user information regarding the first through third e-mail servers 160, 161, and 162. Although the example system in FIG. 2 has three e-mail servers and three e-mail transmitters, the present invention is not limited to such configuration and the Internet fax 200 can be connected to N (a natural number) e-mail servers establishing and managing N e-mail accounts of an Internet fax user, and N e-mail transmitters.

A method of receiving a plurality of e-mails of an Internet fax user with two or more e-mail accounts on any number of e-mail servers will be described next with reference to FIGS. 2 and 3:

At operation 300, a user registers the user information regarding N e-mail servers managing two or more email accounts of the user in the database 210 of the Internet fax 200.

At operation 310, if a command to receive an e-mail is transmitted to the Internet fax 200 from one of the email servers 160, 161 and 162 via paths a and b, at operation 320, the Internet fax 200 dials the ISP 140 and establishes a PPP connection to the ISP 140 via the public switched computer network 130 to connect to the Internet 150. Therefore, at operation 330, the Internet fax 200 can connect to (communicate via) the Internet 150.

The Internet fax 200 connects to the N e-mail servers registered in the data base 210 by determining at operation 340 whether (N−n) is larger than 0, and at operation 350 connects to the n+1 e-mail server. According to an aspect of the invention, ‘n’ is a natural number less than N and corresponding to a number of email servers managing the email accounts of the Internet fax 200 The initial value of ‘n’ is typically set to be 0.

At operation 360, the Internet fax 200 receives (retrieves) e-mails of the Internet fax user from the Internet fax user's e-mail accounts at the connected n+1 email server and when an e-mail is received from the connected mail server, at operation 370, the Internet fax 200 terminates the connection with the n+1 mail server.

After operation 370, with n decremented, the email retrieval process returns to operation 340 to determine whether (N−n) is larger than 0, and if at operation 340 (N−n) is still greater than 0 (i.e., more e-mail servers have to be checked for e-mails), operations 350 through 370 are repeated. Therefore, after operation 370 when other email servers corresponding to the registered email accounts of the Internet fax user remain to be checked to retrieve the emails therefrom, the Internet fax 200 connects to the n+1 email server using the same PPP connection of operation 330. In particular, typically at operation 350, the Internet fax 200 first connects to the email server transmitting the command at operation 310. After operation 370 disconnecting from the command-transmitter email server, based upon the user information of email servers registered at operation 300, operations 350 through 370 are repeated as many times as the number of registered email servers until all emails are received from all other e-mail accounts of the Internet fax user at other email servers.

If, at operation 340, (N−n) is not greater than 0, at operation 380, the Internet fax 200 disconnects the PPP connection from the ISP 140. At operation 390 the Internet fax 200 converts the received e-mails into print data by the converter 120, and, at operation 396 prints the print data by the facsimile 110.

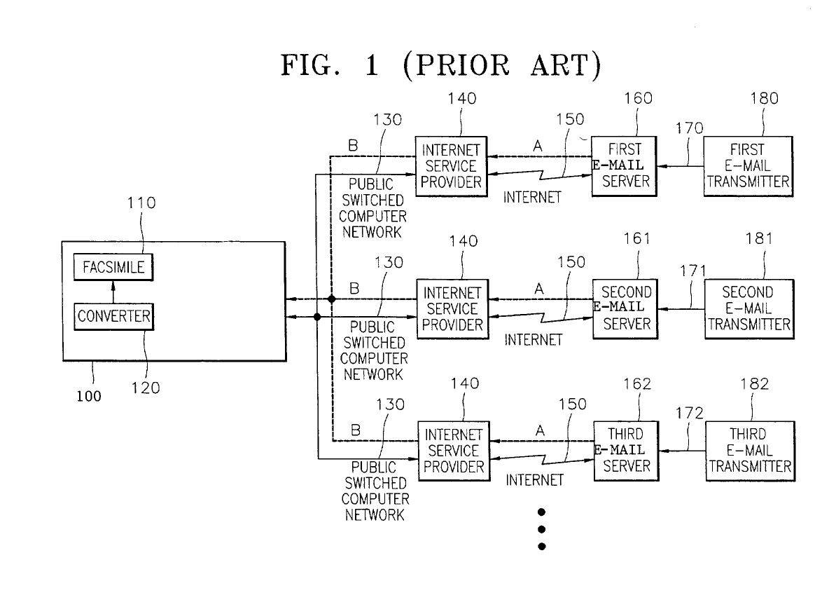

As shown in FIGS. 2 and 3, the Internet fax 200 can be connected to a single ISP 140 (i.e., to establish a single PPP connection via a single ISP) to retrieve user email faxes from two or more user email account at one or any number of email servers. In particular, the first through third email servers 160, 161 and 162 are connected to the Internet fax 200 through the ISP 140. In response to the command of receiving fax data from e-mail servers having different e-mail accounts, the Internet fax 200 can establish a single PPP connection to only one ISP 140, unlike the conventional system of FIG. 1. Also, the Internet fax 200 can receive e-mails from each of the first through third e-mail servers 160 through 162 via the ISP 140, and disconnect the PPP connection from the ISP 140 when all e-mails stored in these email servers are completely received.

Typically, the Internet 200 is a computer running software that embodies processes of the present invention. The present invention is not limited to the email retrieval operation of 340, and other logic can be used to check all email servers used by a user via a single PPP connection via a single Internet service provider. For example, during operations 340 through 370, ‘n’ as well as operations 350-370 can be updated/adjusted if other commands of receiving emails are transmitted to the Internet fax 200, thereby allowing the Internet fax 200 to dynamically continue retrieving email faxes. Further, the command to receive email fax can also be input from a user at the Internet fax 200.

As described above, in a method and system receiving e-mails according to the present invention, an Internet fax can be connected to several e-mail servers to receive e-mails of an Internet fax user stored therein by performing a PPP connection only once, even though the Internet fax user might have several e-mail accounts in one mail server, or several e-mail accounts in several e-mail servers. Therefore, the method and system of the present invention reduces email retrieval time and cost. The method and system of the invention is more convenient than a conventional method for receiving e-mails which establish the PPP connection as many times as the number of e-mail servers, the conventional method thereby increasing email retrieval time and costs.

Although a few preferred embodiments of the present invention have been shown and described, it would be appreciated by those skilled in the art that changes may be made in the embodiments without departing from the principles and spirit of the invention, the scope of which is defined in the claims and their equivalents.

What is claimed is:

1. A method of receiving e-mails via an Internet fax, the method comprising:
setting in the Internet fax at least two e-mail accounts corresponding to email accounts at e-mail servers;
establishing a PPP connection connecting to Internet through an Internet service provider in response to a command for receiving the e-mails;
sequentially receiving the e-mails stored in the e-mail accounts of the e-mail servers through the Internet service provider;
converting data of the received e-mails into print data to be printed by the Internet fax; and
printing the print data.

2. The method of claim 1, further comprising disconnecting the PPP connection from the Internet service provider after the e-mails are completely received.

3. The method of claim 1, further comprising:
registering in advance in the Internet fax user information of an Internet fax user regarding the e-mail servers having the at least two e-mail accounts of the Internet fax user; and
storing the user information in a database.

4. The method of claim 1, wherein the Internet fax dials the Internet service provider through a public switched computer network to establish the PPP connection to the Internet.

5. The method of claim 1, wherein receiving the e-mails comprises connecting the Internet fax to one of the e-mail servers, receiving the e-mails from the connected e-mail server, disconnecting from the e-mail server when the e-mails are completely received, and sequentially connecting to other email servers to receive other e-mails as many times as a number of the e-mail servers.

6. A system receiving e-mails via an Internet fax having a converter converting data from the received e-mail into print data to be printed by a facsimile, the system comprising:
a programmed computer processor setting in the Internet fax at least two e-mail accounts corresponding to emails accounts at email servers, establishing a PPP connection to connect to the Internet through an Internet service provider in response to a command for receiving e-mails, sequentially receiving e-mails stored in the e-mail accounts of the e-mail servers through the Internet service provider, converting data from the received e-mails into print data to be printed by the Internet fax, and printing the print data.

7. The system of claim 6, wherein the Internet fax further comprises a database storing user information of Internet fax users regarding the e-mail servers.

8. A method of receiving emails via an Internet fax, comprising:
registering in the Internet fax at least two email accounts corresponding to email accounts stored on email servers;
establishing a single PPP connection to one of the email servers via Internet through an Internet service provider in response to a command from the one email server for receiving an email fax;
sequentially receiving the email fax stored in the email account of the connected email server and receiving other email faxes stored in other email accounts of the connected email server and other email servers; and
printing the email faxes.

9. An Internet fax, comprising:
a programmed computer processor in communication with Internet, receiving email-fax-retrieval commands from Internet email servers and receiving two or more email faxes of an Internet user from the Internet email servers via a single PPP connection to one of the email servers.

10. A method, comprising:
performing a PPP connection only once if an Internet fax user has several email accounts in one email server or several email accounts in several email servers; and
receiving the several emails of the Internet fax user.
